(19) United States
(12) Patent Application Publication
(10) Pub. No.: US 2008/0201093 A1
(43) Pub. Date: Aug. 21, 2008

(54) Assessment of Weather Damage in Cereal Grains

(76) Inventors: Robert Scott Anderssen, Hughes, ACT (AU); Lewis Bernard Whitbourn, Hunters Hill, NSW (AU); Brian George Osborne, Cowan, NSW (AU); Ian John Wesley, Ryde, NSW (AU); John Kalitsis, East Lakes, NSW (AU)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/914,198

(22) PCT Filed: May 11, 2006
(86) PCT No.: PCT/AU06/00614

§ 371 Date: Feb. 26, 2008

(30) Foreign Application Priority Data
May 13, 2005 (AU) 2005902449

(51) Int. Cl. G06F 19/00

(52) U.S. Cl. 702/81

(57) ABSTRACT

An NIR (near infra red) spectrum is obtained from a cereal grain sample and processed to deduce characteristics related to possible weather damage, for the purpose of assessing sample quality. In addition or alternatively, cereal grain is subjected to a compression test, for example to obtain data below the yield point of the shell of the grain, to determine state of any weather damage. An embodiment includes data processing to assess weather damage from data of NIR spectrum analysis and/or data from compression test analysis; a cross correlation is relevant where either of the NIR and compression tests alone are not sufficiently decisive.

### FIELD OF THE INVENTION

The present invention relates to the assessment of weather damage in cereal grains, and extends to methods and apparatus for such assessment. An important area of application of the invention is to cereal grains which may be damaged by rain, dew or frost on a standing crop. For the purpose of grading and determining fair payment to the supplier, a receival site needs to assess rapidly and with acceptable accuracy the level of the weather damage of the grain received. There may be a need to avoid mixing of grains of different levels of weather damage as different markets may demand different levels and to ensure there is fair and accurate payment to the suppliers.

### BACKGROUND TO THE INVENTION

A long-standing industry challenge is to provide rapid, accurate and objective grain quality assessment at a receival site so that each consignment can be priced. For example, weather damage of wheat can cause pre-harvest sprouting which adversely affects grain quality. This is believed to be due to the release of various amounts of the enzyme alpha-amylase. After the milling of wheat, the flour can be made into a dough and during baking it is the presence of alpha-amylase which causes the conversion of starch in the flour into sugars. Yeast, included in the dough, in turn converts the sugars into carbon dioxide to raise the dough. However, if there is too much alpha-amylase, the result is a build up of intermediates, namely dextrins, and these intermediates cause the breadcrumb to be sticky. Accordingly, the baking industry needs to avoid or minimise the proportion of wheat which has been the subject of pre-harvest weather damage. It follows that wheat having a degree of weather damage beyond a certain limit is unacceptable for food producers and may need to be downgraded for animal food and the producer will receive a much lower payment.

The only test for weather damaged grain accepted for use in international trade is that known as the Falling Number test, devised by Hagberg and Perten, and implemented by Perten Instruments in 1964. A sample of the grain such as wheat is converted to a suspension of meal in hot water which is stirred. Depending on the temperature, there is a competition between the gelatinisation of the starch and its cleavage by the alpha-amylase with the degree of breakdown of the gelatinised starch being an indicative measure of the amount of alpha-amylase present. The greater the amount of alpha-amylase, the faster will be the liquefaction. Briefly, the test comprises measurement of the time for a standard stirrer to sink through a column of suspension. The commercially available system is calibrated to operate from a minimum possible time of 62 seconds (which will apply to badly damaged wheat) to a more typical longer time of greater than 300 seconds for sound wheat. It has been found that for the same instrument and same operator on the same day the precision of the measured value is plus or minus 30 seconds around a typical test value of 300 seconds. However, results vary between instruments and much wider variations have been found. This data is under laboratory conditions but in practice relatively unskilled operators are required to operate under grain-receival conditions and the precision in these circumstances is known to be much worse. Thus, the system has serious limitations, is relatively slow and is potentially very contentious for all concerned with grain which is only marginally above the minimum acceptable degree of weather damage. A fuller description of the principles of the Falling Number test has been given by Chang et al in 1999 in J. Sci. Food Agric., 79 (1999), 19-24.

Consequently, the Falling Number test, when performed as a single estimate, is a poor predictor of the true Falling Number of a sample and thus the extent to which the grain might be weather damaged. Accuracy can be increased by performing a large number of tests and calculating the trimmed mean of the estimates, but this approach is not practical under the time constraints and conditions of receival testing. Details of the Falling Number technology have been published by S Hagberg in 1960 in Cereal Chem., 37 (1960), 218-222, and by H Perten in 1964 in Cereal Chem. 41 (1964), 127-140.

Accordingly there is a longstanding need for more reliable, faster and fairer measurement techniques to be implemented at a receival site for grain.

Assessment of grain to aid in determining its quality has been the subject of other approaches. One example is U.S. Pat. No. 5,005,774 (Martin et al) which describes an automated grain characterisation system for a laboratory. The system is intended for grading and classifying wheat. The system is directed to a single kernel characterisation system by feeding grain into a crushing apparatus with an arrangement for measuring kernel size and a circuit for measuring kernel electrical conductance. A data acquisition and analysis subsystem correlates crushing force, size and conductivity with grain hardness. By comparison with reference samples, the grain characteristics can be determined.

A further U.S. Pat. No. 5,082,141 (also Martin et al) discloses a feeding device to singulate, orient and deliver seeds to a desired destination. The device has a system for feeding single grains and thus may be useful in supplying single grains to the particular apparatus of U.S. Pat. No. 5,005,774.

The scientific literature includes papers reporting on crush-response investigations for different types of wheat. One paper Single Kernel Characterisation Principles and Applications (Osborne and Anderssen:- Cereal Chemistry 80(5):613-612) provides analysis and modelling of crush response profiles for wheat seeds and suggests laboratory approaches to seed comparisons, e.g. as an aid to genetic programme developments.

A further paper discloses results of work on wheat in a paper entitled The Hardness Locus in Australian Wheat Lines Osborne et al Aust. J. Agric. Res., 2001, 52, 1275-1286.

Notwithstanding the above the disclosures, an effective system is still required specifically for weather-damaged cereal grains to be quickly assessed at a receival site.

### SUMMARY OF THE INVENTION

The present invention is based on the realisation that it is possible to determine, in practical and speedy test systems, a distinct characteristic of a grain sample and process data relating to a measurement, to provide a useful indication of the extent of weather damage of the grain sample. A first test is based on the analysis of near infrared (NIR) spectra. This test can be used as an alternative to, or in addition to, a second test which is a physical measurement characterised by the response to a compression test of the sample.

Particularly for grain having little apparent or no extent of weather damage, it will be sufficient to use just one or other of the tests outlined above, as the data will clearly establish the sample as considerably above the minimum standard. Where the data from a single sample is not so decisive, it is possible to meet a commercially acceptable degree of certainty by effecting a large number of sample tests and by taking the trimmed mean of the test results to make a determination. However, the time and cost of such sampling and the delay in the transport and delivery of grain would be considered unacceptable. In such a circumstance, just a single test of the sample using the other of the two tests, with the results suitably combined, can resolve the uncertainty in a quick and decisive manner.

In an embodiment, the invention consists in a method of grading cereal grain with respect to weather damage comprising
(i) choosing a first assessment from the group consisting of (a) subjecting a grain sample to NIR analysis and analysing a spectrum from the sample for the degree of characterisation related to potential weather damage of the grain and providing an indicative output signal thereof; and (b) subjecting a sample of the grain to a compression test under an applied force and monitoring the applied force against compression to provide an output signal related to compression response and indicative of the extent to which the sample has weather damage;
(ii) assessing the indicative output from the selected test and grading the cereal grain if and only if the output decisively falls into a particular established grade, but if the indicative output is not decisive, proceeding to the other of the tests to obtain of further indicative output and then and (iii) processing output signals corresponding to the indicative output of at least one of the two tests to determine the grade of the grains.

In practice it is well established to use NIR inspection of samples of grain at a receival site to assess the grain for other factors such as moisture content and protein content. Therefore the option of using the NIR test for weather damage as proposed herein can be conveniently integrated into that sampling process and produce a very speedy result which is decisive if the grain is clearly considerably in excess of the standard or for that matter, well below the standard for weather damage. If this test is not sufficiently clearcut, then compression testing and cross correlating the data can provide a quick, fair and certain outcome.

Embodiments of the invention make use of a known biochemical pathway which is initiated in cereal grains by the onset of weather damage. As a result of this pathway, weather damage changes the elastic characteristics of the aleurone and viscoelastic response of the endosperm layers of wheat. Embodiments can use a compression test, described in more detail below, specifically in a selected manner to make a rheological assessment (i.e. flow characteristics) of the elasticity of the aleurone layer or shell. Weather damage also causes a chemical change to the grains and embodiments utilise an NIR technique to assess the chemical change. Especially combining two such data sets can provide a very useful indicator of weather damage. Specifically embodiments are aimed at providing a clear and unambiguous differentiation between weather damaged and sound grain.

The scientific literature has acknowledged that NIR data partially correlates with Falling Number data for a sample having sprouting damage due to rain. A paper reporting on this observation is Shashikumar et al (1993) Cereal Foods World 38, 364-366. However there is no suggestion that NIR alone is a useful technique because even if a trimmed mean of a large number of replicas is used, the accuracy is poor compared with the standard Falling Number test which is itself not considered to be an adequate and applicable effective methodology for receival site purposes.

More specifically, the present disclosure proposes an embodiment using an NIR spectrum analysis in which analysis is made of the two most appropriate principal components, calculated as described in Chapter 5, Multivariate Calibration and Classification, Naes T, Isaksson T, Fearn T and Davies T, NIR Publications, Chichester, UK, of a sample spectrum and a comparison is made with stored values to provide an output signal indicative of the extent to which grain damage has occurred due to weather. The principal components can be calculated as described in Chapter 5, Multivariate Calibration and Classification, Naes T, Isaksson T, Fearn T and Davies T, NIR Publications, Chichester, UK.

It should be explained that this test does not seek to correlate readings with known Falling Number tests but instead proposes a substitute which observes the effect of molecular changes in samples, rather than an indirect assessment of some parameter linked with a physical/chemical reaction. Thus, it is suggested the present disclosure lends itself to more valid specific data although there is recognition that there will be a large degree of experimental error unless measurement results for a number of samples are averaged, specifically for cases near the acceptable limit.

The invention manifests itself in several aspects, including a testing methodology, apparatus for the method and a software package using algorithms to manipulate NIR data and/or compression response data to provide an output signal indicative of the grain characteristics. Furthermore, another aspect is the provision of a website or other data processing service for effecting such analysis.

As discussed in more detail below, a further inventive aspect of the present disclosure is a novel arrangement to produce and select an important characteristic of the compression response curve as valid data for an indication of weather damage. Although the published literature (such as the Osborne and Anderssen paper referred to above), reports on the response to crushing forces applied to single grains, what has not previously been suggested, and is now disclosed as an inventive development, is that bulk sample analysis of compression below the yield point of the shell is relevant data to the assessment of weather damage. It is now disclosed that, relative to an appropriate standard, the softer the structure of the grain, the more will be the degree of weather damage as a direct correlation of the change to the grain structure as discussed above.

A most significant proposal now made is that by combining data from both an NIR spectrum analysis and a compression response analysis, a high degree of precision can be achieved. This can provide accuracy and sensitivity, particular to grain which is marginal having regard to the acceptable degree of weather damage. Particularly, with preferred embodiments, this is because the degree of uncertainty from one of the tests is applied to the results from the other test with a totally different degree of uncertainty so that there is a high probability that the combined analysis has a higher degree of precision. Consequently, this combined technique will have fairness to producers and purchasers of grain yet the system is capable of being implemented in a practical way which can be operated economically and speedily at grain receival sites. Thus disputes about accuracy of measurement and grading of grain, compared with Falling Number systems, should be much reduced.

In a method aspect, a particular embodiment comprises analysing an NIR spectrum of a grain sample and providing data indicative of elements of the spectrum suggesting grain damage, effecting a compression test on a grain sample and determining its elastic response to compression and providing data indicative of physical characteristics correlated with weather damage and finally cross correlating the two sets of data to provide an output signal indicative of the grain quality.

More specifically, this methodology is suitable to be implemented where the two most appropriate principal components of the NIR spectrum are combined and the compression test is effected by determining the compression response below the crushing or yield point of the grain shells.

More particularly, embodiments lend themselves to small bulk sample assessment e.g. of the order of 100 grams which facilitates physical handling at a grain receival facility and obviates complex machinery such as the prior art machinery discussed above for single kernel handling and analysis.

In summary, in the space of a few minutes, grain can be sampled and analysis made to determine whether it meets a prescribed standard for weather damage or not. In practice, it has been customary to have a distinct pass/fail test but it is suggested that embodiments of the invention may lend themselves to a new standard system where grain of different grades may be assessed with an acceptable degree of certainty. For example, for manufacturers of food products for humans, a particularly high standard of grain might be required for some products such as noodles, but a lower standard, i.e. a higher degree of weather damage may be acceptable for other products.

An embodiment may be defined as a method of assessment of cereal grains comprising:
(i) the following steps in either order or simultaneously;
   (a) subjecting a grain sample to NIR analysis and analysing a spectrum from the sample for the degree of characterisation related to potential weather damage of the grain and providing an indicative output signal thereof;
   (b) subjecting a sample of the grain to compression and monitoring the force resisting compression to provide an output signal related to compression response and indicative of the extent to which the sample has weather damage and
(ii) processing in the output signals from steps (a) and (b) to provide a combined output signal indicative of whether the grain sample has weather damage.

The present invention also manifests itself in apparatus arranged to provide the methodology described above.

A further manifestation is in a signal processing methodology or apparatus or computer software package for data manipulation adapted to receive signals derived in accordance with steps (a) or (b) above and effecting the processing described in step (ii) above.

The invention also manifests itself in a data processing facility including a website and specifically adapted to effect the processing of step (ii) above.

A more specific form of embodiment is one in which a small bulk grain sample, perhaps of the order of 100 grams is used for the NIR spectral assessment and the compression test. Conveniently the NIR spectral derivation can be the first step and can be effected simultaneously with other NIR analysis, such as analysis for protein and moisture contents. If possible weather damage needs further assessment, then the compression test could be effected and the results then combined.

One effective approach is to use NIR reflectance data which can be derived from a test cell adapted for use at a grain receival site and thus can be entirely self-contained. A microprocessor can thus be used to analyse the spectrum in terms of the two most appropriate principal components and it has been found in this example that by plotting the First Principal Component against the Second Principal Component, remarkably useful data is derived. A further most useful step is then to determine the polar theta value for the sample value derived from the previous step of graphically plotting the First Principal Component against Second Principal Component and then the polar theta value for the sample lends itself to a single number conveniently characterising what is observed in the 2-dimensional plot.

In practice a multiplicity of spectra from single sample are quickly taken and processed to facilitate averaging and thus precision. In the case of a sample which is marginal, there will be typically a spread of the output data around that which corresponds with an agreed standard or limit and when combination is made with the compressive test data, the uncertainty is resolved somewhat decisively.

The compression test data is most effectively derived by loading a sample into a cylinder which is vibrated to cause rapid natural settling of the sample and axial compression of the grain in the cylinder is effected with force applied through a piston. A plot is made of the response, typically in terms of the time to achieve a defined force resisting compression.

These particular embodiments exploit the realisation that there are physical and chemical changes to cereal grains when subjected to weather damage, each of which is thus somewhat indicative of weather damage and both are related such that the methodology proposed, by determining and combining the parameters measured permits a decisive assessment to be made in a manner which can be effected quickly, e.g. within a few minutes. This is possible without highly skilled operators at a grain receival site where there do not need to be sophisticated laboratory facilities. Consequently, waiting time of heavy transport vehicles at a receival site may be minimised.

Reference will now be made to the accompanying drawings of which:

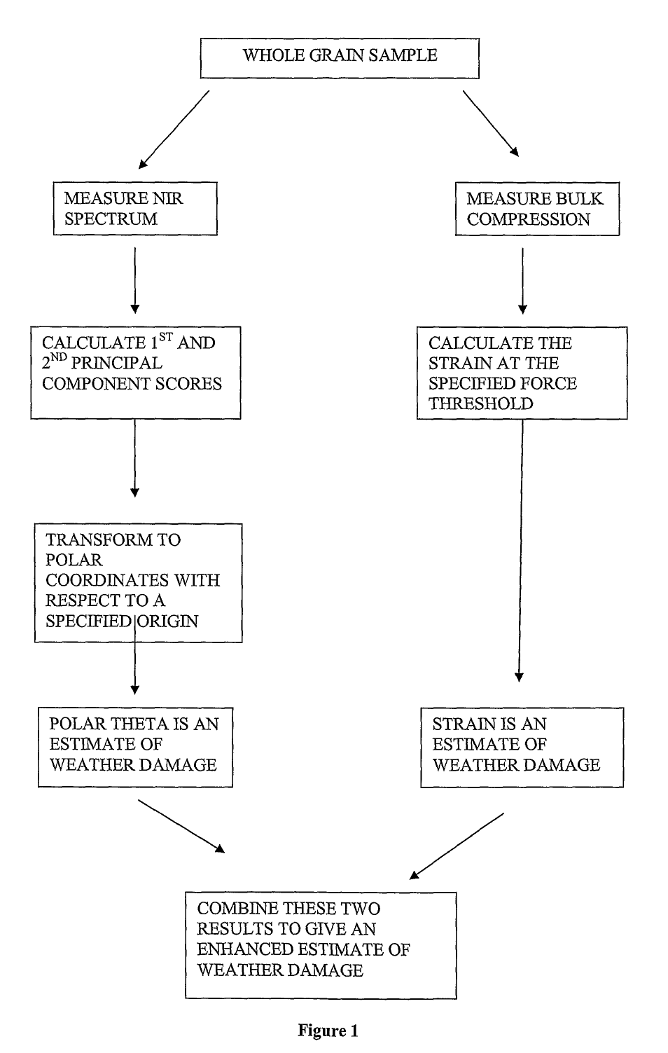

FIG. 1 shows a combined scheme of separately effecting NIR spectrum analysis and compression derived data of small bulk samples of grain. The combined cross-correlated data resolves uncertainty in the assessment of either test alone.

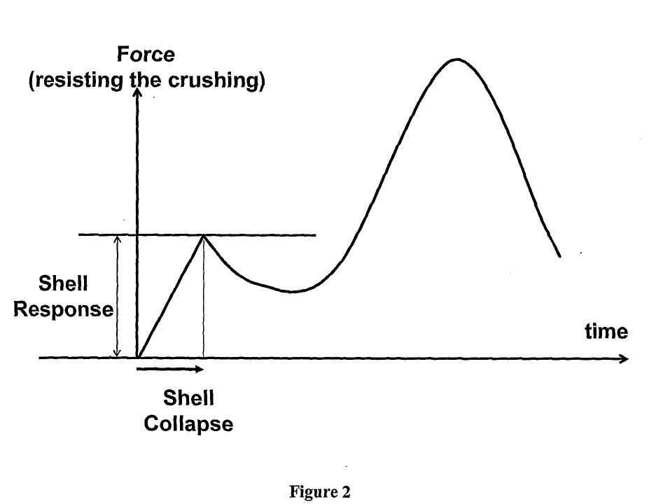

FIG. 2 is an illustration of an average crushing response to applied compressive force on single wheat grains using the SKCS 4100 apparatus referred to above;

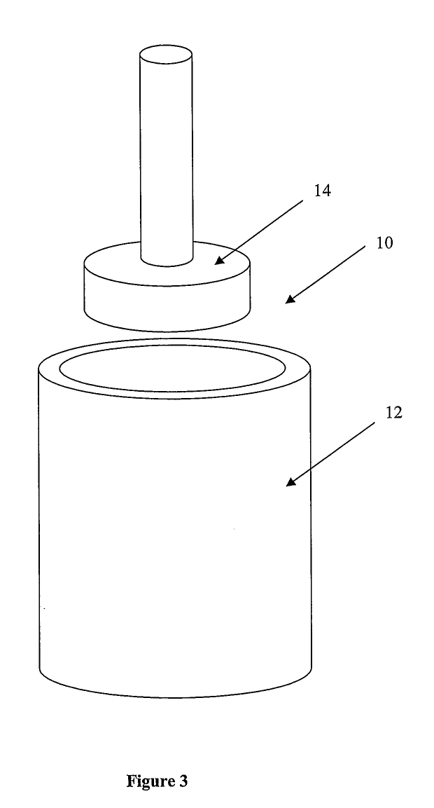

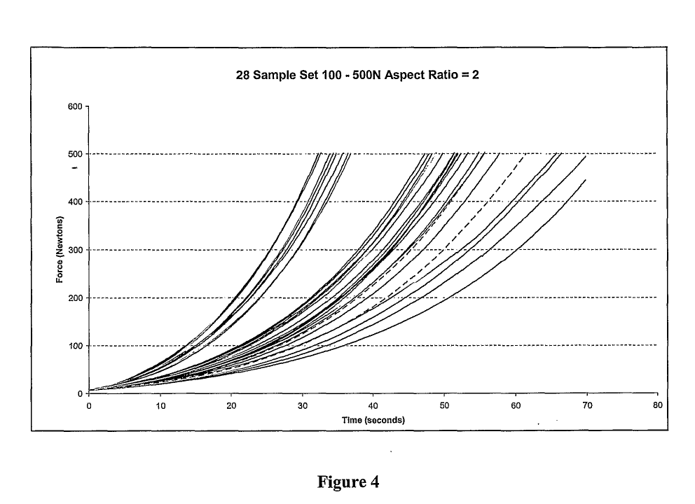

FIG. 3 is a schematic illustration of a compression machine for producing the data of FIG. 4;

FIG. 4 is data representative of an embodiment of the invention and comprising compression-response curves for small bulk samples of wheat grains;

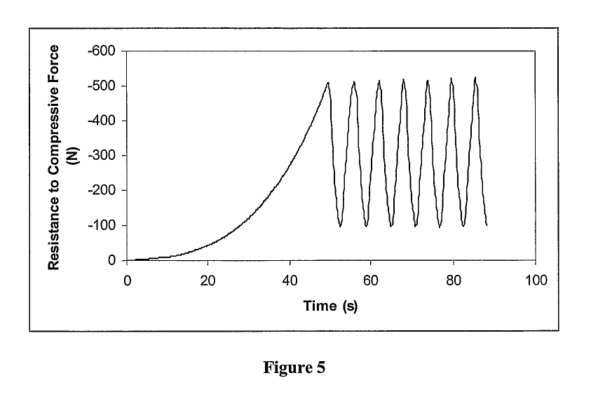

FIG. 5 is a diagram of measured force resisting compression against time, from which is usefully deduced the time difference between the first compression and the seventh compression;

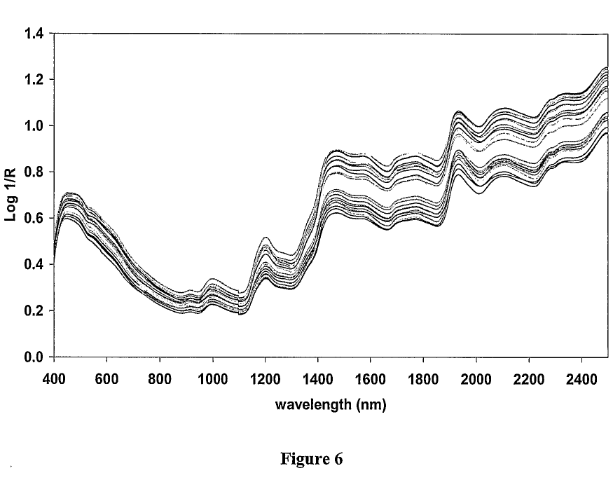

FIG. 6 is a set of NIR spectra derived from small bulk samples of wheat grain;

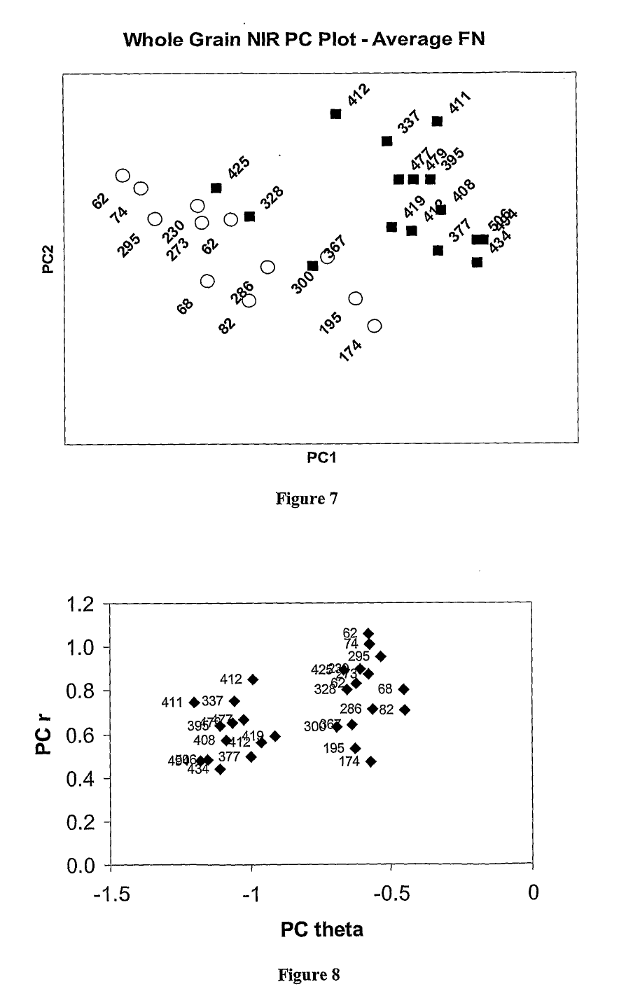

FIG. 7 is a plot of values derived from the spectra of FIG. 6 of the Second Principal Component plotted against the First Principal Component. This is an example of classification based on principal components as described in Section 18.5.1, Multivariate Calibration and Classification, Naes T, Isaksson T, Fearn T and Davies T, NIR Publications, Chichester, UK,;

FIG. 8 is a plot of the radial distance against polar theta value (in radians) calculated from the data of FIG. 7 by converting Cartesian co-ordinates into polar co-ordinates with respect to a specified origin, used as a method of converting the information in the two principal components (shown in FIG. 7) into a single value;

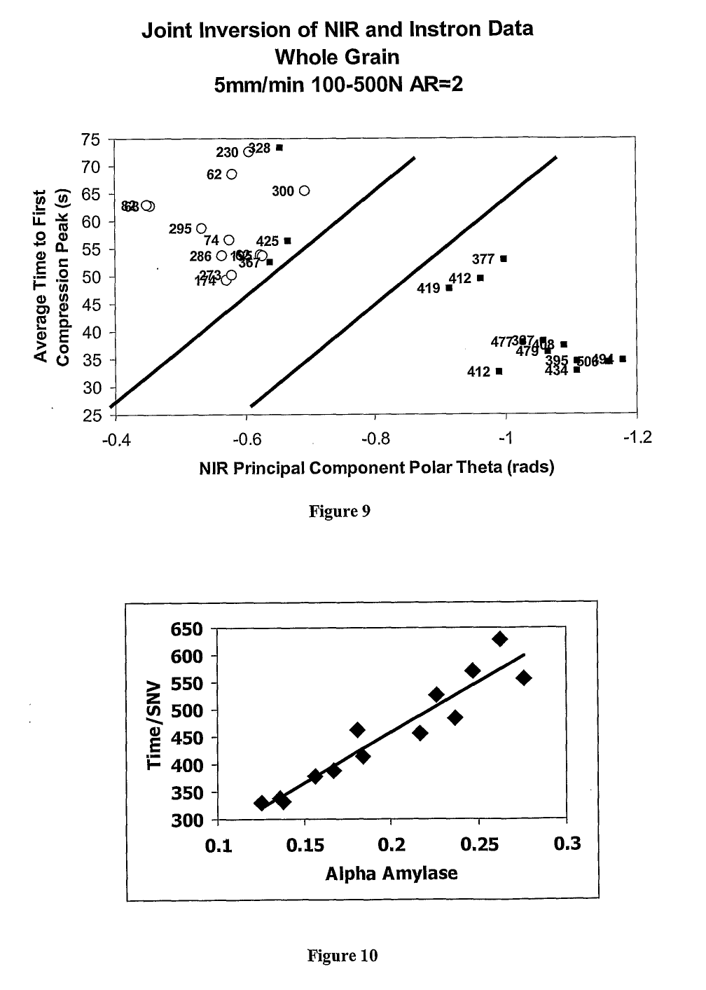

FIG. 9 is a plot of the polar theta values as represented in FIG. 8 against compression-response curve data for the same samples, the diagram being marked to show a representation of lines between which is a zone within which would a somewhat arbitrary division between sound grain and weather damaged grain. This is an example of the recovery of information through a joint inversion of two independent measurement modalities, such as that described by Anderssen R S, Carter E, Osborne B G and Wesley I J (2005). Joint inversion of multi-modal spectroscopic data of wheat flours. Applied Spectroscopy, 59, 920-925; and

FIG. 10 is a plot of the value of time/SNV against alpha amylase; time is to the seventh compression derived as indicated in FIG. 5 and standard normal variate scattering coefficient (SNV) (is calculated from the data as alternative pre-processing using the method described by Barnes R J, Dhanoa M S and Lister S J (1989) “Standard normal variate transformation and detrending of near infrared diffuse reflectance” Applied Spectroscopy, 43, 772-777.)

Weather damage due to rain in standing grain crops such as wheat causes initiation of sprouting which is a natural mechanism which occurs when grain has been planted in the soil and moisture conditions are suitable for germination. The biochemical pathway is that water reacts with wheat germ in the grain and gibberellic acid is generated and that, in turn, causes synthesis of alpha-amylase and together with enzymic breakdown of cellular structure results in starch in the grain to be broken down by the alpha-amylase to produce sugars for the germ to grow. This biochemical pathway coincides with significant changes in the elastic strength of the aleurone layer and the viscoelastic strength of the endosperm layer of the wheat and these chemical changes can be monitored by NIR and the associated physical changes can be monitored by a rheological assessment of the elasticity of the aleurone layer which provides effectively a shell for each wheat grain. Thus two separate and independent measurement modalities are available and can be combined to give a clear and unambiguous differentiation between sound and weather damaged wheat.

Referring now to FIG. 2, the single kernel characteristics observed were acknowledged in the Osborne and Anderssen paper referred to above. It will be noted that compressive force is applied for an extended period and initially there is a response of the shell of the kernel up to a yield point at which the shell collapses and subsequently, with continued application of force, there is the endosperm response as illustrated.

The embodiment uses data responsive to compression up to a specified maximum force which is determined to be clearly less than that which is liable to cause crushing of the shell.

FIG. 3 illustrates schematically an apparatus 10 for effecting a compression test and comprises a cylindrical vessel 12 of suitable dimensions to receive a grain sample of about 100 grams and to be compressed at a steady compressive rate through a plunger 14. The plunger is driven at a constant rate of about 5 mm/min.

FIG. 4 provides compression response data for a wide range of examples of wheat samples of varying degree of weather damage. Group A are those samples with significant weather damage (corresponding to average Falling Numbers below 300 seconds) and Group B are those with little or no weather damage (corresponding to average Falling Numbers above 300 seconds). A separation between the two groups is evident. In this force-controlled compression protocol, the difference between the sound and weather damaged wheat samples can be simply assessed as the time in seconds taken to reach the first force maximum.

However, an alternative approach is illustrated in FIG. 5 where the characterising time to assess weather damage is that from monitoring 7 compression cycles and the time is the elapse from the first compression peak to the seventh compression peak.

Referring now to FIG. 6, the recorded reflective spectra (plotted as the logarithms of their reciprocals) for a large number of samples having differing degrees of rain damage is displayed and for which a gross discrimination between two groupings is evident. However, neither the data of FIG. 6 nor that of FIG. 4 clearly discriminate between samples of small degrees of weather damage until, by further processing, significantly enhanced discrimination can occur.

NIR reflectance spectra through the range of 400-2,500 nm as illustrated in FIG. 6 are scatter-corrected, second derivate spectra. It is the First Principal Component and the Second Principal Component which are derived and then plotted as illustrated in FIG. 7.

The main variation in the Principal Component plots reflects the change in the scattering coefficient of the sample that results from weather damage. Therefore, an alternative pre-processing of the spectral data is to calculate the standard normal variate scattering coefficient [see Barnes, R. J., M. S. Dhanoa and S. J. Lister (1989): “Standard normal variate transformation and de-trending of near infrared diffuse reflectance spectra” Applied Spectroscopy 43(5): 772-777]. This value neatly summarizes the spectral differences that can be attributed to changes in the scattering coefficient of the sample.

FIG. 8 illustrates the expression of the data of FIG. 7 in polar coordinates from which the values of NIR Principal Component Polar Theta in radians are derived. The NIR spectral data for a sample can thus be expressed as a single number.

When the compression data (Average time to first compression peaks) and NIR data (NIR Principal Component Polar Theta value in rads) are plotted as in FIG. 9, then a clear separation of the two groups “weather damaged” and “not weather damaged” is apparent. The synergy permits decisive analysis using different physical responses to weather damage.

A alternative approach is for the NIR spectrum to be calculated as the standard normal variate coefficient of the sample spectrum and to provide an output signal indicative of the extent of weather damage relying on the relationship that Time/SNV increase as shown in FIG. 10 with alpha amylase levels which increase with increased amount of weather damage. The values derived may be plotted against the compression data to determine the extent of weather damage.

1. A method of assessment of a cereal grain sample comprising obtaining and analysing an NIR spectrum from the sample and deducing therefrom characteristics of the sample related to weather damage.

2. A method as claimed in claim 1 and wherein the NIR spectrum is analysed by analysing one suitable Principal Component against another suitable Principal Component of the sample spectrum and comparing the data with stored values to provide an output signal indicative of the extent to which the grain has been damaged due to weather.

3. A method as claimed in claim 2 and wherein the NIR spectrum is analysed by combining the First Principal Component of the spectrum with the Second Principal Component of the spectrum to provide a combined output.

4. A method as claimed in claim 1 and further subjecting a sample of the grain to a compression test and using compression response data below the yield point of the shell to determine the sample characteristics.

5. A method as claimed in claim 5 and comprising establishing a set of data based on NIR sampling, establishing a second set of data based on compression test response sampling and combining the two sets of data to provide an output indicative of the degree of weather damage in the grain sample.

6. A method as claimed in claim 5 and wherein the data from the compression test monitors elastic response and the data of the NIR spectrum is selected to be indicative of characteristics of grain damage, the two sets of data being combined to provide an output signal indicative of the grain quality.

7. A method of assessment of cereal grains comprising the following steps in either order or simultaneously;
(a) subjecting a grain sample to NIR analysis and analysing a spectrum from the sample for the degree of characterisation related to potential weather damage of the grain and providing an indicative output signal thereof;
(b) compressing a sample of the grain and monitoring the reactive force against compression to provide an output signal related to compression response and indicative of the extent to which the sample has weather damage; and
processing in the output signals from steps (a) and (b) to provide a combined output signal indicative of the extent to which the grain sample has weather damage.

8. A method of assessing cereal grain for weather damage comprising subjecting a sample to a compression test and using compression response data below the yield point of the shell to determine the sample characteristics.

9. A method of grading cereal grain with respect to weather damage comprising
(i) choosing a first assessment from the group consisting of
(a) subjecting a grain sample to NIR analysis and analysing a spectrum from the sample for the degree of characterisation related to potential weather damage of the grain and providing an indicative output signal thereof, and
(b) subjecting a sample of the grain to a compression test under an applied force and monitoring the applied force against compression to provide an output signal related to compression response and indicative of the extent to which the sample has weather damage;
(ii) assessing the indicative output from the selected test and grading the cereal grain if and only if the output decisively falls into a particular established grade, but if the indicative output is not decisive, proceeding to the other of the tests to obtain of further indicative output and
(iii) processing output signals corresponding to the indicative output of at least one of the tests to determine the grade of the grains.

10. A method as claimed in claim 9, wherein the method is effected on a sample of cereal grain of the order of 100 grams.

11. A method as claimed in claim 10, wherein the event test (a) is used, the method includes analysing the NIR by combining one Principal Component of the spectrum with another Principal Component of the spectrum to provide a combined output.

12. A method as claimed in claim 11, wherein the First Principal Component is correlated against the Second Principal Component of the NIR spectrum which is derived from reflectance data, the polar theta characteristics are determined with respect to a specified origin and data corresponding to such characteristics is used in a correlation with data from the compression test.

13. A method as claimed in claim 9, wherein the event test (b) is used the method includes supplying a test sample of cereal grain to test apparatus having a receiving cavity, vibrating the cavity to settle the sample, applying a pressure through an application element onto the sample with applied compression and monitoring the reactive response over time and using data from the compression test below the yield point of the shells of the grains.

14. A method as claimed in claim 1, wherein the NIR spectrum is analysed by calculating the standard normal variate coefficient of the sample spectrum and comparing the data with stored values to provide an output signal indicative of the extent to which the grain has been damaged due to weather.

15. Computer software for output data from the test or tests conducted by the method claimed in claim 9, the computer software being adapted to manipulate and cross-correlate the data to provide an output indication of the degree of weather damage.

16. A website having data analysis procedures for receiving data from a method as defined in claim 9 and processing data to provide an output indicative of weather damage.

17. An apparatus for sampling cereal grain samples for possible weather damage comprising a first data processor for receiving data relating to an NIR spectrum derived from examination of a sample of cereal grain and processing the data to produce an output indicative of the degree of characterisation of the grain related to a grading system concern with weather damage of grain, and a second data processor adapted to receive data from a compression test measuring the response of pressure over time on a sample of the cereal grain subjected to the values below the yield point of the shells of the grain, and means for cross correlating the output of the first and the second data processors to indicate the determined grade of the cereal grain.

18. Apparatus as claimed in claim 17 and including a cereal grain sample receiving device, NIR monitoring apparatus for producing an NIR spectrum and monitoring the spectrum for analysis and for providing data to the first processor.

19. Apparatus as claimed in claim 17 and further comprising a compression test apparatus having and receiving cavity for receiving a sample of the cereal grain, applying compression to the sample over time and having means for monitoring the reactive response to the applied compression below the yield point of the shells of the grain and providing an output signal to the second processor.

20. Apparatus as claimed in claim 17 and further having signal processing for practicing the analysis of data in accordance with the method defined in any one of claims 1 to 14.

21. A data processing system having input means for receiving and cross-correlating data indicative of possible weather damage of grain, the input means comprising a first input for data derived by subjecting a grain sample to NIR analysis and analysing a spectrum from the sample for the degree of characterisation related to potential weather damage of the grain and providing an indicative output signal thereof and second input means for data derived by subjecting a sample of the grain to a compression test under an applied compression and monitoring the reactive force against compression to provide an output signal related to compression response and indicative of the extent to which the sample has weather damage.

22. A data processing system as claimed in claim 21 and further comprising a data processor for cross-correlating the output signals from the first data and the second data to determine the extent of weather damage in the grain sample.
